(19) United States
(12) Patent Application Publication
(10) Pub. No.: US 2008/0278876 A1
(43) Pub. Date: Nov. 13, 2008

(54) Method for Diagnosing a Control Circuit

(76) Inventors: Bernd Kudicke, Brackenheim (DE); Thoralf Rosahl, Eningen (DE)

Correspondence Address: KENYON & KENYON LLP, ONE BROADWAY, NEW YORK, NY, 10004, US

(21) Appl. No.: 11/579,308

(22) PCT Filed: Apr. 5, 2005
(86) PCT No.: PCT/EP2005/051519

§ 371 Date: Mar. 11, 2008

(30) Foreign Application Priority Data
Apr. 30, 2004 (DE) 10 2004 021 377.1

(51) Int. Cl. H02H 3/00

(52) U.S. Cl. 361/94

(57) ABSTRACT

A method for diagnosing control circuits having at least one actuator, in particular of a fuel injection device, is provided. Before operation of a given control circuit, this control circuit and the at least one actuator are tested for short-circuits, and an error response is initiated if a short-circuit is present.

### FIELD OF THE INVENTION

The present invention is directed to a method for diagnosing control circuits having at least one actuator, in particular a capacitive actuator of a fuel injection device.

The subject matter of the present invention also includes a device for triggering control circuits, in particular a control unit of an internal combustion engine, and a computer program product for carrying out the method according to the present invention on a computer or control unit.

### BACKGROUND INFORMATION

Actuators of this kind, which operate on a capacitive or inductive basis, are used with fuel injection devices of internal combustion engines, in particular those having direct fuel injection. If piezoelectric actuators are used as capacitive actuators, a valve element of the fuel injection device is moved from an open to a closed position and vice-versa based on changes in the length of the piezoelectric actuator. However, if there is a short-circuit in a line to a piezoelectric actuator, in the piezoelectric actuator itself, in a control circuit, or in a control unit which triggers the piezoelectric actuator, it is no longer possible to properly trigger the piezoelectric actuator. Furthermore, this may also impair the functioning of more than one piezoelectric actuator. In a best-case scenario, this may make the ride less comfortable; in an unfavorable scenario, it worsens the internal combustion engine's fuel consumption and emission behavior; and in an extreme scenario it may endanger the user of the internal combustion engine.

A method in which the voltage with which a capacitive element of a piezoelectric actuator is charged and discharged is ascertained and used to determine the capacitance of the capacitive element is known from European Patent Application No. EP 1 138 907. The capacitance ascertained may then be used to infer whether there is a short-circuit in the piezoelectric actuator being tested.

### SUMMARY OF THE INVENTION

The method according to the present invention has the advantage that before each operation of a given control circuit for triggering at least one actuator, this control circuit and the at least one actuator are tested for short-circuits, and an error response is initiated if a short-circuit is present. This has the special advantage that it is ensured before each operation of the control circuit that the control circuit being triggered does not have a short-circuit.

According to a further advantageous embodiment, a highside output stage path of the control circuit is tested for short-circuits to ground and battery, and in a lowside output stage path of the control circuit each individual actuator is tested for short-circuits to ground and battery. This has the special advantage that not only may a short-circuit be assigned to a specific control circuit, but also the error path with regard to highside or lowside may be reliably identified.

It is particularly advantageous that, before the control circuit in question is tested for short-circuits, a pre-test is performed in which first a highside switch element is closed and a test is subsequently performed to determine whether a bank voltage exceeds a threshold value following a pre-test time. If, by the end of the pre-test time, the bank voltage exceeds the operating threshold value, it may be assumed that no short-circuit is present and in principle no further testing for short-circuits is necessary. However, if, after the pre-test time, the bank voltage has not exceeded the threshold value, there is probably a short-circuit in the control circuit, and further detailed testing of the control circuit for short-circuits must be initiated. This procedure has the particular advantage that detailed testing for short-circuits is performed only if, there are indications in advance suggesting a short-circuit.

According to a further advantageous embodiment, as an error response, the control circuit in which a short-circuit has been detected is blocked. Thanks to this and, in particular, a rapid error response after detection of a short-circuit, advantageously there is no need for the control circuit output stage to be resistant to sustained short-circuits. It is thus sufficient to design the output stage short-circuit-proof but not necessarily resistant to sustained short-circuits, which means that cost-effective components and mechanical components may be used. Furthermore, by dispensing with additional components that would be required to be resistant to sustained short-circuits, the amount of heat to be dissipated is reduced.

According to a further advantageous embodiment, a device for triggering control circuits having at least one actuator is provided, the device being designed for example as a control unit of an internal combustion engine and programmed for using at least one method according to the present invention. Thus, in an advantageous manner, short-circuit diagnosis may be handled centrally by a control unit and also further measures in addition to the error responses may be initiated, for example.

According to a further advantageous embodiment, the method according to the present invention is stored as a computer program product having a program code, and is stored on a machine-readable medium so that in an advantageous manner the method may be carried out when the program is executed on a computer or a control unit.

### BRIEF DESCRIPTION OF THE DRAWINGS

FIG. 1 schematically shows a control circuit for two capacitive actuators.

FIG. 2 shows the diagram of a triggering sequence of a test for short-circuits according to the present invention.

FIG. 3 schematically shows a flow chart for the method according to the present invention.

### DETAILED DESCRIPTION

The present invention is based on the notion that an output stage for triggering actuators need not necessarily be resistant to sustained short-circuits, provided it is ensured the output stage does not trigger any control circuit having a sustained short-circuit. According to the present invention, before operation of an actuator, the control circuit in question and the actuators themselves are tested for short-circuits. If a short-circuit is found, preferably the control circuit in question is blocked to prevent further operation, output stage triggering in particular.

Typically actuators in an internal combustion engine are grouped together in a shared control circuit. These groups of actuators are commonly known as a bank or bank system. In the case of a six-cylinder internal combustion engine, for example three bank systems each having two actuators may be provided.

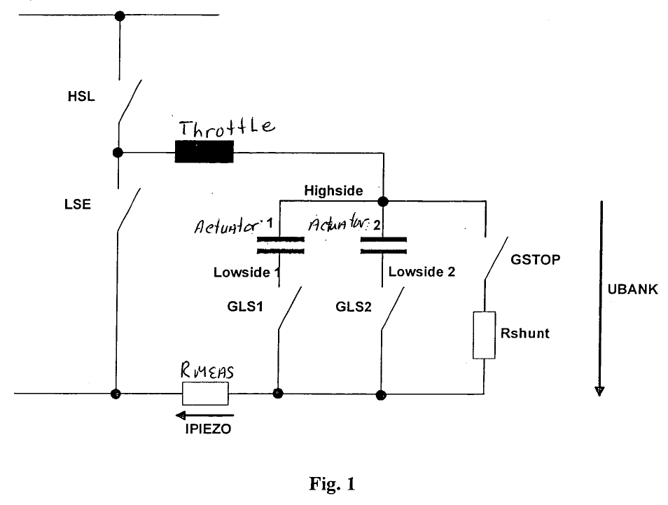

FIG. 1 schematically shows a control circuit for two capacitive actuators. In FIG. 1, a first and a second actuator are shown as actuator 1 and actuator 2. A terminal on the highside of each actuator (actuator 1, 2) is connected, via a shared lead, to an inductor, the inductor being connectable either to a supply line via a highside switch element HSL or to a ground line via a lowside switch element LSE. The electrical connection of the actuators (actuator 1, 2) to the supply line via the shared supply conductors, the inductor, and the highside switch element are referred to as the highside output stage path.

On the other terminal side of the actuators (actuator 1, 2), referred to as the lowside, the terminal of first actuator 1 is connected to a first lowside switch element GLS1, and the terminal of second actuator 2 is connected to a second lowside switch element GLS2, the two switch elements GLS1, GLS2 connecting the two actuators 1, 2 to a shared lowside supply conductor. The shared lowside supply conductor is connected to the ground line via a measuring shunt Rmeas. The electrical path from the terminal of each respective actuator 1, 2, via the accompanying lowside switch element GLS1, GLS2, the lowside supply conductor, and measuring shunt Rmeas to the ground line, is also referred to as the lowside output stage path 1, 2.

A bridging switch element GSTOP, which connects the highside of the actuators to the lowside supply conductor via a shunt resistor Rshunt, is situated parallel to the actuators. In the exemplary embodiment of FIG. 1, all switches and switch elements are shown as open. The voltage drop across the actuators is referred to as bank voltage UBANK. The voltage drop across measuring shunt Rmeas is proportional to piezoelectric current IPIEZO.

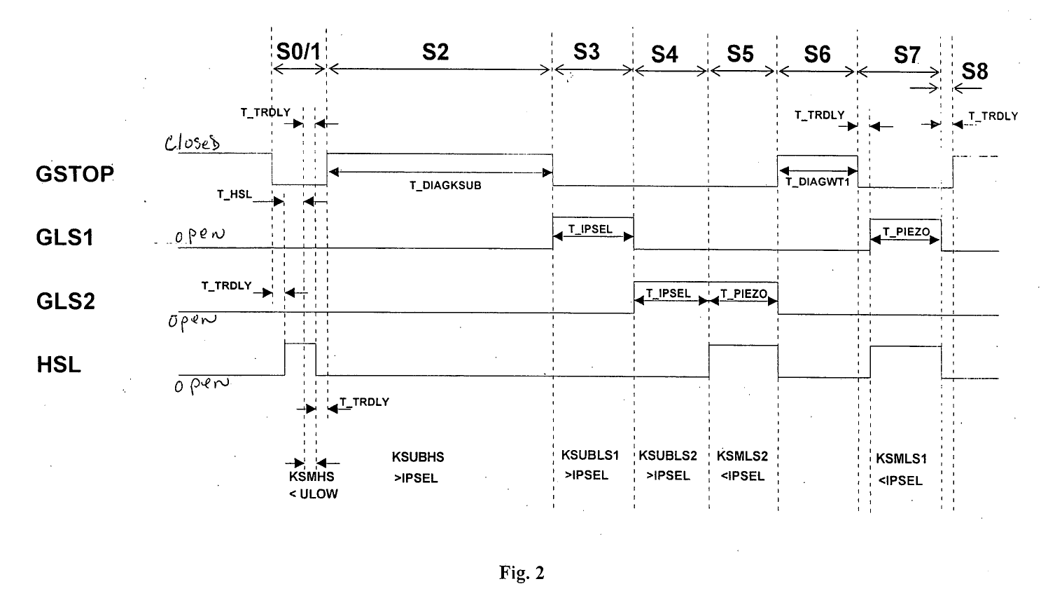

FIG. 2 shows the time sequence for triggering the various switch elements of the control circuit to allow testing for short-circuits. If the control circuit is not in operation, all switch elements except bridging switch element GSTOP are open.

If the control circuit is to be operated, the bridging switch element is opened, and then highside switch element HSL is closed after wait time T_TRDLY. If, after or during a pre-test time T_HSL starting from closed highside switch element HSL, bank voltage UBANK attains or exceeds an operating threshold value U_HSL, it is assumed there is no short-circuit in the control circuit, which is then enabled and goes into ordinary operating mode. The checking of bank voltage UBANK at the start of operation of the control circuit is used virtually as a pre-test S0 for short-circuits in the control circuit to be operated.

If, in pre-test S0, operating threshold value U_HSL was not exceeded, first step S1 of the more complete short-circuit testing is initiated, highside switch element HSL remaining closed and a further wait time T_TRDLY following directly after pre-test time T_HSL of pre-test S0. If, during this additional wait time T_TRDLY, bank voltage UBANK remains below a minimum threshold value ULOW, “short-circuit to ground on highside output stage path” KSMHS is present and an error response is initiated. In the absence of an error response, at the end of wait time T_TRDLY highside switch element HSL is opened again and bridging switch element GSTOP is closed after a further subsequent wait time T_TRDLY.

In a second step S2, a diagnosis wait time T_DIAGKSUB follows. As highside switch element HSL is open during this time, no current should flow from the highside via bridging switch element GSTOP to shunt resistor Rshunt and measuring shunt Rmeas. However, if piezoelectric current IPIEZO measured across measuring shunt Rmeas exceeds a current threshold IPSEL, “short-circuit to Ubatt (battery voltage or supply voltage) on highside output stage path” KSUBHS is detected and an error response is initiated. In the absence of an error response, bridging switch element GSTOP is opened at the end of diagnosis wait time T_DIAGKSUB.

In a third step S3, first lowside switch element GLS1 is closed for a time period T_IPSEL. If, during this time T_IPSEL, current threshold IPSEL is exceeded, “short-circuit to Ubatt (battery voltage or supply voltage) on lowside output stage path 1” KSUBLS1 is present and an error response is initiated.

At the beginning of subsequent fourth step S4, first lowside switch element GLS1 is opened again and second lowside switch element GLS2 is closed. Similarly to third step S3, “short-circuit to Ubatt (battery voltage or supply voltage) on lowside output stage path 2)” KSUBLS2 is present if piezoelectric current IPIEZO exceeds current threshold IPSEL.

In fifth step S5, in addition to second lowside switch element GLS2, highside switch element HSL is also closed. If, after a piezoelectric control time T_PIEZO, piezoelectric current IPIEZO does not exceed current threshold value IPSEL, “short-circuit to ground on lowside output stage path 2)” KSMLS2 is present and an error response is initiated.

In order to set defined states for subsequent measuring, in a sixth step S6 bridging switch element GSTOP is closed and second lowside switch element GLS2 and highside switch element HSL are opened.

After a discharge wait time T_DIAGWT1, a seventh step S7 begins and bridging switch element GSTOP is opened again. After an additional wait time T_TRDLY, first lowside switch element GLS1 and highside switch element HSL are closed for a piezoelectric control time period T_PIEZO. If, after a piezoelectric control time T_PIEZO, the piezoelectric current does not exceed current threshold value IPSEL, “short-circuit to ground on lowside output stage path 1” KSMLS1 is present and an error response is initiated.

After piezoelectric control time T_PIEZO, in an eighth step S8 first lowside switch element GLS1 and highside switch element HSL are opened, and after a further wait time T_TRDLY bridging switch element GSTOP is closed, so that after the end of eighth step S8 the switch elements assume in the same state as before the beginning of first step S1.

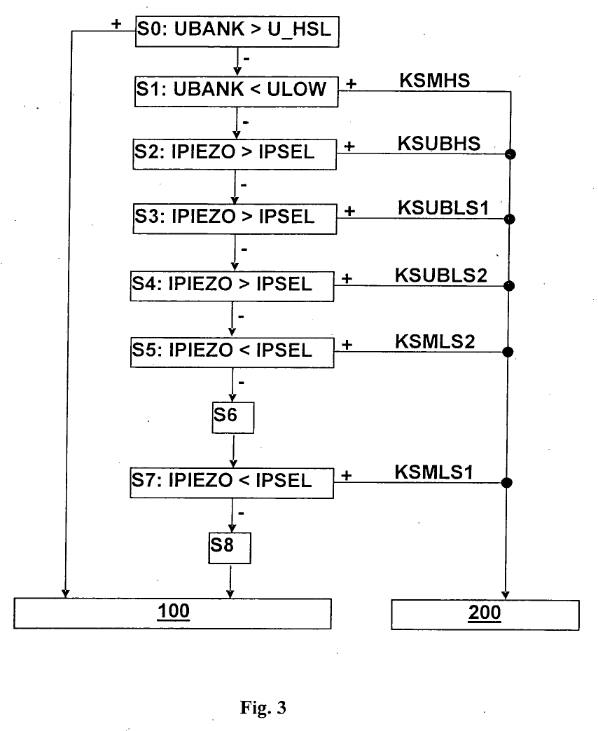

FIG. 3 schematically shows the flow chart for short-circuit testing according to the present invention, steps S0 to S7 corresponding to the steps described and illustrated in FIG. 2 based on the corresponding switch element positions.

Step S0 is essentially a pre-test in which, on the basis of a test criterion, it is ascertained whether or not the control circuit to be operated has a short-circuit.

Further method steps S1 to S7 are carried out only if the result of the pre-test suggests a short-circuit in the control circuit. In steps S1 to S5 and S7, based on specific switch element positions and corresponding test queries, a short-circuit present is then detected and the precise location of the error determined.

In step S0, a test is performed to determine whether, by the end of pre-test time T_HSL, bank voltage UBANK exceeds an operating threshold value U_HSL. If the result of the test is positive, the control circuit is enabled in step 100. The more complete short-circuit testing is initiated via a first step S1 only if the result is negative.

In step S1, a test is performed to determine whether, after an additional wait time, bank voltage UBANK remains below a minimum threshold value ULOW. If minimum threshold value ULOW is not exceeded, there is a short-circuit to ground on highside output stage path KSMHS and the method branches to step 200, which initiates an error response.

In second step S2, the error response is initiated in step 200 if piezoelectric current IPIEZO exceeds current threshold IPSEL, which indicates a short-circuit to Ubatt (battery voltage or supply voltage) on highside output stage path KSUBHS.

In third step S3, a short-circuit to Ubatt (battery voltage or supply voltage) on lowside output stage path 1 KSUBLS1 is detected and the error response initiated in step 200 if piezoelectric current IPIEZO exceeds current threshold IPSEL.

In fourth step S4, a short-circuit to Ubatt (battery voltage or supply voltage) on lowside output stage path 2 KSUBLS2 is detected and the error response initiated in step 200 if piezoelectric current IPIEZO exceeds current threshold IPSEL.

In fifth step S5, a short-circuit to ground on lowside output stage path 2 KSMLS2 is detected and the error response initiated in step 200 if piezoelectric current IPIEZO remains below current threshold IPSEL.

In sixth step S6, the next step is prepared without testing the measured results.

In seventh step S7, a short-circuit to ground on lowside output stage path 1 KSMLS1 is detected and the error response initiated in step 200 if piezoelectric current IPIEZO remains below current threshold IPSEL. If, furthermore, no short-circuit is detected in the last test in seventh step S7, in the subsequent eighth step S8 the switch elements are switched back to the state in which they were before the beginning of first step S1. After this, the control circuit is enabled in subsequent step 100.

The method according to the present invention has the advantage, in particular in steps S2 to S5 and S7, that testing for short-circuits is carried out based on current measurements. This method has the particular advantage of being essentially independent of cable lengths or the electrical capacitances of the actuators. Therefore, in particular aging effects, for example in the piezoelectric injectors, only play a minor role in short-circuit diagnosis.

Furthermore, when a short-circuit is detected, the control circuit is blocked as an error response and is thus no longer available for any further triggering. In the case of a six-cylinder internal combustion engine having three control circuits/banks having two actuators each, in the event of a short-circuit in a control circuit, this circuit would be rendered inoperative, so that the internal combustion engine would be operated using the remaining two control circuits, i.e., four triggered cylinders.

Without short-circuit detection, there is the danger that the output stage for triggering the actuators may be overloaded due to repeated triggering of a control circuit having a short-circuit, and as a result permanently damaged, which would lead to complete failure of actuator triggering. The internal combustion engine would then be inoperable and, depending on the vehicle's situation, the driver might be at risk or exposed to unacceptable dangers.

Using the method according to the present invention, it is ensured that even if there is a short-circuit in the control circuits of the actuators, the internal combustion engine may be operated at least to a limited extent, thus avoiding risk to the driver.

Moreover, using the method according to the present invention, the type of short-circuit is ascertained, so that during repair the corresponding information may be retrieved and the error quickly narrowed down to allow reliable repair.

Furthermore, in the case of the method according to the present invention it is not absolutely necessary for the triggering output stage to be resistant to sustained short-circuits, because before each operation the control circuit is tested for short-circuits and blocked as necessary. This ensures that the output stage is not operated in a sustained short-circuit state. Nevertheless, a short-circuit to ground or to the supply voltage may arise in the corresponding control circuit or due to the actuator itself as an actuator is triggered. To ensure proper operability of overall triggering in such an event, the output stage is advantageously designed so that brief short-circuits do not damage the output stage. If the control circuit having the short-circuit is triggered in the next cycle, a short-circuit is detected using the method according to the present invention and the control circuit is blocked. Repeated load on the output stage due to a short-circuit is thus advantageously avoided. It is therefore sufficient for the output stage to be designed so that short-term short-circuits are withstood. Additional reserves and more generous dimensioning of the electronic and mechanical components to ensure resistance to sustained short-circuits is thus not necessary. Thanks to this method, more cost-effective electronic and mechanical components may be used in the output stage, and furthermore the output stage may have a more compact design, and as a result the amount of heat to be dissipated is reduced.

According to a further exemplary embodiment, it is also conceivable to use inductive actuators instead of piezoelectric actuators, in particular electromechanical actuators. Herein, the method according to the present invention is used in a similar manner.

Furthermore, it is advantageous to provide a device for triggering control circuits, in particular an internal combustion engine control unit having means for detecting short-circuits, the device being programmed to use the method according to the present invention. Herein, the program may be for example stored as a computer program product having program code on a machine-readable medium.

Furthermore, all positions of the switch elements, wait times, measuring times, threshold values, and other data may be provided in a characteristics map.

Furthermore, the threshold values and the wait times/measuring times may be defined as a function of the internal combustion engine's operating conditions and/or the mechanical/electrical properties of the actuators. In particular, it is also conceivable to assign these values individually for each control circuit and to each actuator, and to take them into account accordingly.

Furthermore, the method according to the present invention may also be saved as a program or functionality on an electronic component, e.g., an EPROM, ASIC or the like, and to run it in a control unit or in particular also directly in an output stage.

Moreover, the control circuits themselves may be included as part of the output stage, so that triggering and power supply functionalities are also feasible in a form that differs from that described. In particular, the supply line does not necessarily have to be at battery potential, and the ground line does not necessarily have to be at ground potential. Output stage approaches in which the actuators are triggered via pulse-width modulated current/voltage are also conceivable.

1-7. (canceled)

8. A method for diagnosing a control circuit having at least one actuator, comprising:
before operation of the control circuit, testing the control circuit and the at least one actuator for short-circuits, and initiating an error response if a short circuit is present.

9. The method according to claim 8, wherein the method is for diagnosing a fuel injection device.

10. The method according to claim 8, further comprising testing a highside output stage path of the control circuit for short-circuits to ground and battery, and in a lowside output stage path of the control circuit, testing each individual actuator for short-circuits to ground and battery.

11. The method according to claim 10, further comprising, before the control circuit is tested for short-circuits, first closing a highside switch element, then performing a test to determine whether, after a pre-test time, a bank voltage exceeds an operating threshold value, and testing the control circuit for short-circuits only if, after the pre-test time, the bank voltage does not exceed the operating threshold value.

12. The method according to claim 8, further comprising, in order to test for a short-circuit to ground, first closing a highside switch element on a highside output stage path in the control circuit, then performing a test to determine whether, after the pre-test time and an additional wait time, a bank voltage has exceeded a minimum threshold value, and, if the minimum threshold value has not been exceed, initiating an error response.

13. The method according to claim 8, further comprising, as an error response, blocking the control circuit in which a short-circuit has been detected.

14. A device for triggering a control circuit having at least one actuator, comprising:
means for detecting short-circuits, the means for detecting performing the following:
before operation of the control circuit, testing the control circuit and the at least one actuator for short-circuits, and initiating an error response if a short circuit is present.

15. The device according to claim 14, wherein the device is for triggering a control unit of an internal combustion engine.

16. A computer-readable medium containing a program which when executed by a processor performs the following steps for diagnosing a control circuit having a least one actuator:
before operation of the control circuit, testing the control circuit and the at least one actuator for short-circuits, and initiating an error response if a short circuit is present.
